(19) United States
(12) Patent Application Publication
(10) Pub. No.: US 2018/0221887 A1
(43) Pub. Date: Aug. 9, 2018

(54) CRUSHING MILL AND METHOD FOR CRUSHING REFUSE

(71) Applicant: COLOMBO GIOVANNI S.R.L., Daverio (IT)

(72) Inventor: Claudio Colombo, Varese (IT)

(21) Appl. No.: 15/746,678

(22) PCT Filed: Jul. 22, 2016
(86) PCT No.: PCT/IB2016/054396

§ 371 Date: Jan. 22, 2018

(30) Foreign Application Priority Data
Jul. 23, 2015 (IT) 102015000037563

(51) Int. Cl. B02C 13/286; B02C 13/02

(52) U.S. Cl. CPC B02C 13/286; B02C 2201/06; B02C 2013/28627; B02C 13/02

(57) ABSTRACT

Crushing mill including a crushing chamber, an inlet pipe of the refuse to be crushed connected to the crushing chamber, and a thruster member associated to the inlet pipe; the crushing mill includes a compactor apparatus for the refuse to be crushed provided with one or more presser elements positioned in correspondence to the inlet pipe of the refuse to be crushed and configured to be moved from at least a first inactive position, in which they allow the loading of the refuse to be crushed into the inlet pipe, to at least a second active position in which they compact the refuse in the pipe; the mass of compacted refuse in the inlet pipe is sent to the crushing chamber by means of the thruster member.

### FIELD OF THE INVENTION

The present invention concerns a crushing mill, usable for example in a refuse disposal plant for crushing scrap, such as for example vehicles, trailers, collected materials or other, in which the scrap is loaded and crushed to reduce its size.

In particular, the present invention concerns a crushing mill provided with an apparatus for compacting refuse.

The present invention also concerns a method for crushing refuse.

### BACKGROUND OF THE INVENTION

Crushing mills for crushing scrap are known, used in refuse disposal plants.

Known crushing mills comprise a crushing chamber in which a crushing device is housed, provided with a plurality of crushing hammers moved by a corresponding motor or other drive member. The crushing chamber is disposed downstream of a feed device suitable to introduce the scrap to be crushed into the chamber. The feed device is normally associated with means for conveying the scrap, like a slide or a hopper, which allows to load the scrap or refuse into an inlet pipe located in an open box situated upstream of the crushing chamber. When the refuse to be crushed reaches the inlet pipe, it is taken toward an aperture to be inserted inside the crushing chamber by thrust means.

One disadvantage of known crushing mills is that, when the refuse reaches the inlet pipe, it mainly consists of an incoherent mass of scrap or refuse of any shape, size and volume, and therefore the thrust means that have to thrust it toward the crushing chamber have difficulty in operating and are not very efficient on the mass, with the consequence that the crushing process is made not very efficient or continuous.

Another disadvantage of known mills is that, during the crushing process, refuse being crushed can spill from the crushing chamber and return toward the feed box where the inlet pipe is provided, with obvious problems of safety of the crushing plant.

One purpose of the present invention is therefore to obtain a crushing mill that overcomes the shortcomings of known crushing mills cited above and that allows to subject the refuse to a rapid, uniform and efficient crushing, whatever the type, shape or volume of the refuse to be crushed.

Another purpose of the present invention is to obtain a completely safe crushing mill, in which unwanted spillage of the refuse to be treated or in the process of being crushed is prevented, from any side of the mill, and therefore spillage is prevented from the crushing chamber and/or the inlet pipe of the feed box.

Another purpose of the present invention is to obtain a crushing mill with a continuous functioning that prevents any downtimes, or at least limits them to the utmost.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, a crushing mill comprises a crushing chamber, an inlet pipe of the refuse to be crushed connected to the crushing chamber, and a thruster member associated to the inlet pipe and moveable between at least an inactive position of loading the refuse to be crushed into the pipe and one or more active positions of thrusting the refuse to be crushed toward the crushing chamber.

The crushing mill is characterized in that it comprises a compactor apparatus for the refuse to be crushed provided with one or more presser elements positioned in correspondence to the inlet pipe of the refuse to be crushed and configured to be moved from at least a first inactive position, in which they allow the loading of the refuse to be crushed into the inlet pipe, to at least a second active position in which they compact the refuse in the inlet pipe; the mass of compacted refuse in the inlet pipe is sent to the crushing chamber by means of the thruster member.

Advantageously, by means of the present crushing mill it is possible to proceed with the crushing of refuse or scrap of any shape, volume or size. Thanks to the compactor apparatus with which the crushing mill is provided, it is possible to achieve a compacting of the refuse as soon as it is introduced into the inlet pipe, in order to obtain a mass of compacted refuse that can be transferred rapidly and efficiently toward the crushing chamber. The thruster member is able to bring the compacted refuse toward the crushing chamber and its functioning can be advantageously synchronized with the refuse loading and compacting steps, so as to render the crushing process of the present mill suitably continuous.

According to another aspect of the invention, the crushing mill comprises an introduction element positioned between the compactor apparatus and the crushing chamber, so as to selectively open or close the access to the crushing chamber.

According to another aspect, the introduction element is in an opening or closing position of the crushing chamber when at least one of the presser elements closes or opens the inlet pipe of the refuse.

Advantageously, by means of the introduction element, the crushing chamber is always kept closed toward the outside, always guaranteeing an optimal safety of the present crushing mill since, when the introduction element is raised, one of the presser elements is lowered and, vice versa, when the introduction element is lowered, the presser elements can both be raised.

The present invention also concerns a method for treating refuse, such as scrap, that comprises moving a thruster member associated to an inlet pipe between an inactive position in which the refuse is loaded into the pipe and one or more active positions of thrusting the refuse in which the refuse is thrust toward a crushing chamber to be crushed.

According to one characteristic of the method, after the refuse has been loaded into the pipe, it is compacted with a compactor apparatus; during the compacting, the method provides to move one or more presser elements, positioned in correspondence to the pipe, between a first inactive position, in which they allow the loading of the refuse into the pipe, and a second active position, in which they compact the refuse in the pipe; the mass of compacted refuse is then sent to the crushing chamber by means of the thruster member.

According to another aspect of the present method, open and closed steps of the crushing chamber are provided, synchronized with the closed and open steps of the inlet pipe to load the refuse to be treated, so that the crushing chamber is always closed toward the outside.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a perspective view of a crushing mill according to the present invention;

FIG. 2 is a perspective view in longitudinal section of a part of the present crushing mill;

FIG. 3a is a first view in cross section of a compactor apparatus into which a first mass of refuse or scrap to be crushed is loaded;

FIG. 3b is a second view in cross section of the compactor apparatus in an introduction step of the refuse inside it;

FIG. 3c is a third view in cross section of the compactor apparatus in a compacting step of the mass of refuse;

FIG. 3d is a fourth view in cross section of the compactor apparatus, into which a new mass of refuse is loaded, while the mass previously loaded and compacted is transferred to the crushing chamber;

FIG. 4a is a first view in longitudinal section of the present crushing mill in an initial thrust step of a compacted mass of refuse toward a crushing chamber of the crushing mill;

FIG. 4b is a second view in longitudinal section of the present crushing mill in a final thrust step of the compacted mass of refuse toward the crushing chamber;

FIG. 4c is a third view in longitudinal section of the present crushing mill in an initial re-entry step of the thruster means of the compacted mass of refuse and lowering of an introduction element;

FIG. 4d is a fourth view in longitudinal section of the present crushing mill with the thruster means of the compacted mass of refuse in a re-entered position and with the introduction element in a completely lowered position.

To facilitate comprehension, the same reference numbers have been used, where possible, to identify identical common elements in the drawings.

### DETAILED DESCRIPTION OF SOME EMBODIMENTS

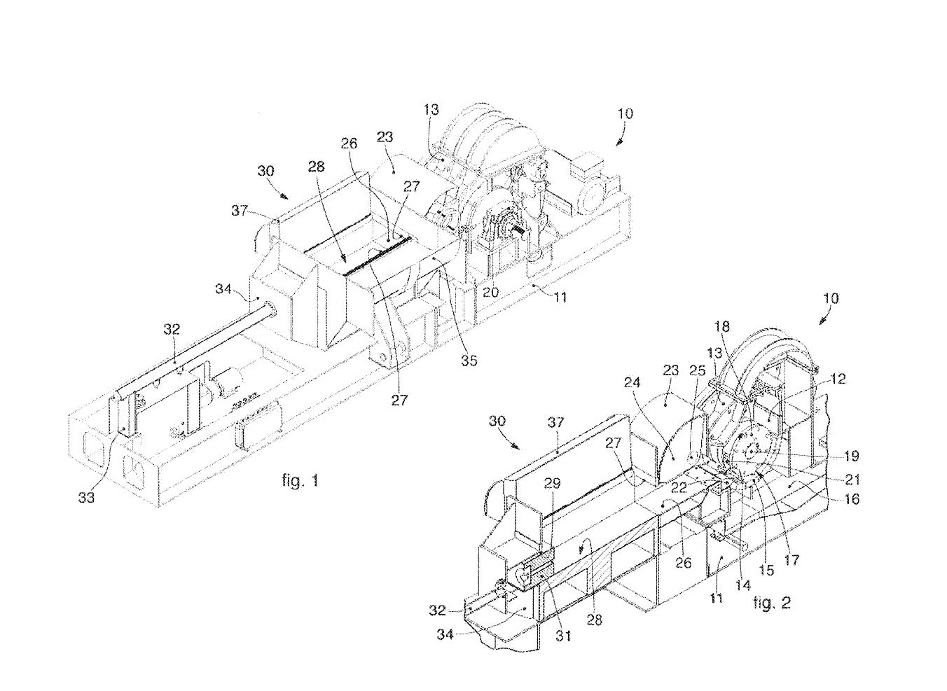

With reference to the attached drawings and in particular to FIGS. 1 and 2, a crushing mill according to the present invention is indicated by the reference number 10. The crushing mill 10 comprises a base 11 above which a crushing chamber 12 is positioned, closed by a suitable containing structure 13. The crushing chamber 12 comprises an inlet aperture 14 of the refuse to be treated and a bottom 15, from which the crushed refuse can be transferred onto a vibrating transporter 16 housed in the base 11 of the crushing mill 10. The bottom 15 can be provided with a grid or suchlike for sieving the crushed refuse. The function of the vibrating transporter 16 is to discharge the crushed refuse from the crushing mill 10.

Inside the crushing chamber 12 a crushing device 17 is housed that comprises a rotor 18, cylindrical in shape and provided centrally with a substantially horizontal rotation shaft 19. The rotor 18 is supported by suitable supports 20, for example bearings, and will be connected to drive means, for example an electric motor with adjustable speed or suchlike. The rotor 18 has a series of crushing hammers 21 along the periphery, preferably equidistant from each other. The refuse or scrap to be crushed reach the crushing chamber 12 by means of a slide, the terminal part 22 of which can be seen.

Upstream of the crushing chamber 12 a box 23 is shown, for housing an introduction element 24, shaped as a cylindrical sector and able to rotate round a rotation shaft 25 by suitable drive means, not visible in the drawings. The function of the introduction element 24 is to thrust the terminal part of the compacted refuse into the crushing chamber 12 and to close the access to the inlet aperture 14 of the crushing chamber 12.

In the zone under the introduction element 24 a pipe 26 is provided, of a box-like or parallelepiped shape, suitable to transfer a compacted mass of refuse to the crushing chamber 12.

The transfer pipe 26 communicates by means of a suitable mouth 27 with an inlet pipe 28 of a compactor apparatus 30. The inlet pipe 28 has a shape and size corresponding to the transfer pipe 26 and the mouth 27, that is, it has a parallelepiped or box-like shape and is open at the top to allow loading of refuse. The mass of refuse or scrap to be crushed by the crushing mill 10 is offloaded into the inlet pipe 28. The inlet pipe 28 is therefore delimited at one end by the mouth 27 through which a mass of compacted refuse is transferred to the transfer pipe 26 and, at the other end, by an aperture 29. The aperture 29 has a cross section corresponding to the cross section of the inlet pipe 28 and the mouth 27, and through it a parallelepiped thruster member 31 can enter and exit. The thruster member 31 can slide backward and forward in the inlet pipe 28, through the mouth 27 and into the transfer pipe 26. The thruster member 31 can be driven by any suitable drive mean, for example a linear actuator or suchlike and is connected for this purpose to a rod 32 that is supported and guided by suitable supports 33 and 34.

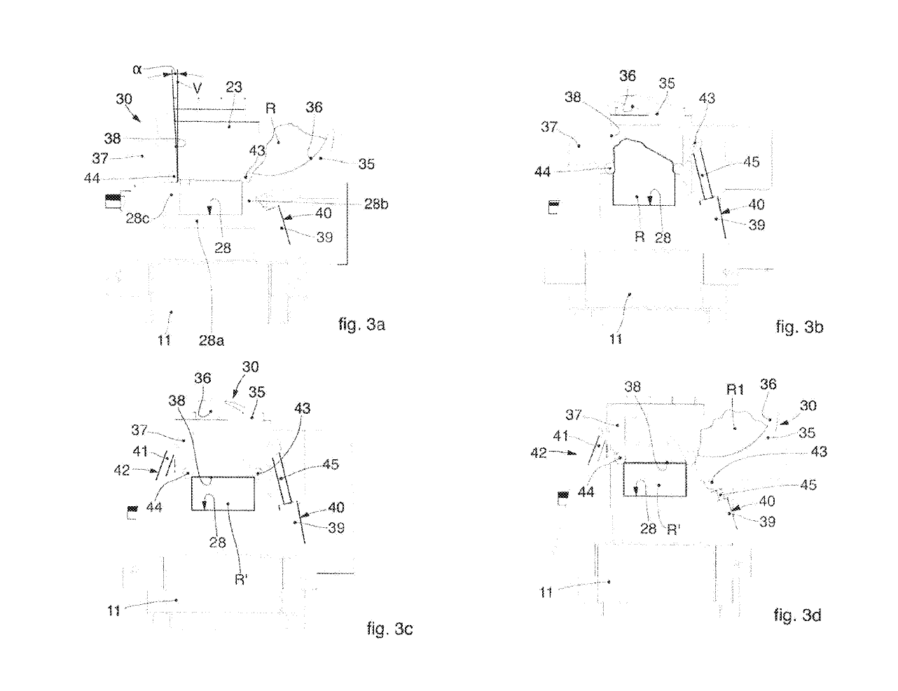

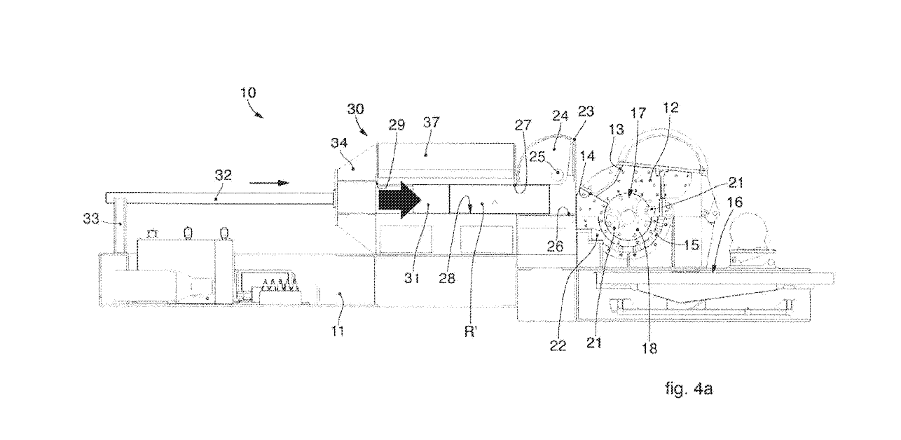

The inlet pipe 28 for the mass of refuse R to be treated (see FIG. 3a), is substantially U-shaped and comprises a bottom wall 28a and two lateral walls 28b and 28c. On the top of the lateral wall 28b one end of a first presser element 35 is connected, by means of one or more rotation pins 43, and comprises an arched surface 36, in which a first mass R of refuse or scrap to be crushed is offloaded.

On the top of the lateral wall 28c, instead, one end of a second presser element 37 is connected, by means of one or more rotation pins 44, and comprises a flat pressing surface 38. The presser elements 35 and 37 are driven by corresponding actuators: FIG. 3a shows the cylinder 39 of the actuator 40 that drives the first presser element 35, and in FIG. 3c the plunger 41 of the actuator 42 that drives the second presser element 37 can be partly seen. In order to facilitate the introduction of the mass of refuse R into the inlet pipe 28, the flat pressing surface 38 of the second presser element 37, during the loading step, has a certain inclination with an angle α with respect to a vertical plane V. The angle α can be comprised for example between 0° and 20°.

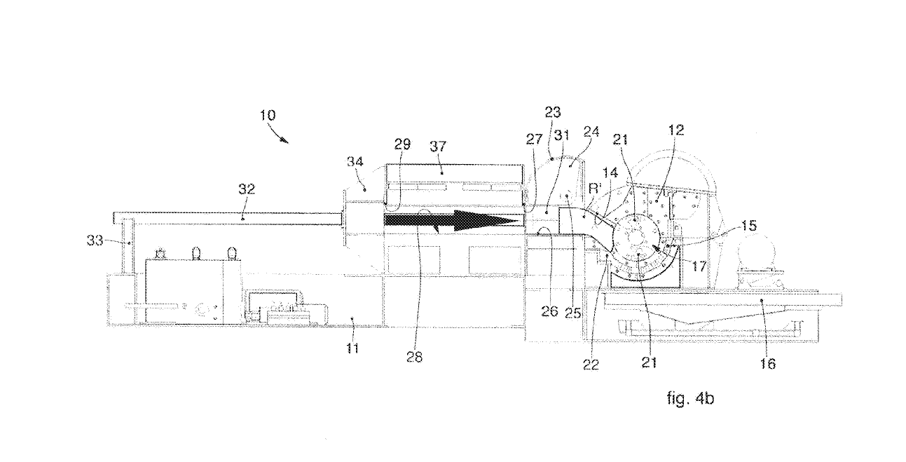

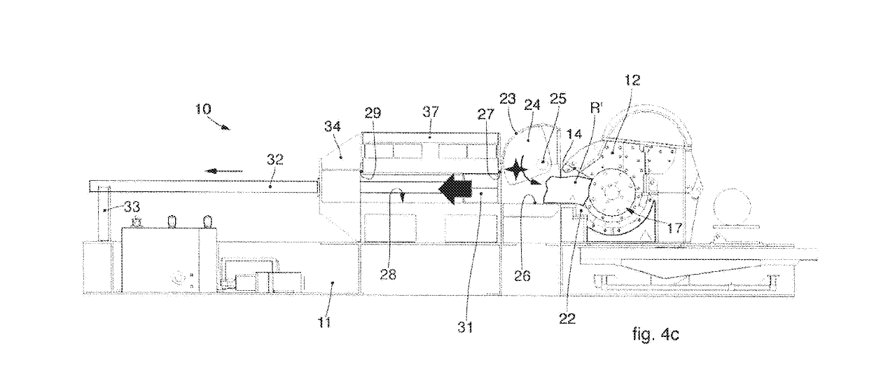

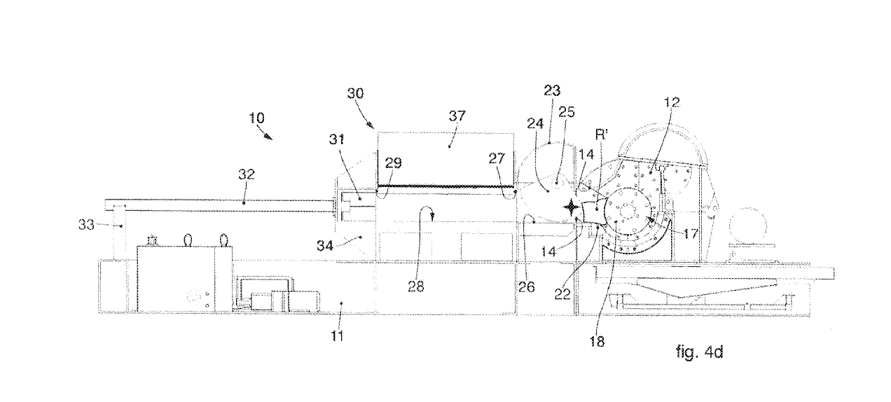

During the loading of a mass of refuse R into the compactor apparatus 30, the thruster member 31 is in a retracted position and remains outside the inlet pipe 28 (see FIG. 4d for example), so as not to interfere with the loading step of the refuse R. Moreover, the introduction element 24 closes access to the crushing chamber 12.

In a first compacting step of the refuse R (see FIG. 3b), the actuator 40, which comprises a plunger 45 pivoted on the external wall of the first presser element 35, makes the first presser element 35 rotate around the rotation pin 43 so that its arched surface 36 thrusts the mass of refuse R to be crushed partly downward and partly toward the second presser element 37.

The first presser element 35 is stopped in a position such that it does not interfere with the subsequent rotation of the second presser element 37. By means of the plunger 41 with which the corresponding actuator 42 is provided (see FIG. 3c), the second presser element 37 is rotated around the rotation pin 44 and toward the first presser element 35 until its flat pressing surface 38 is in a practically horizontal position.

In this way a compacted mass of refuse R′ is obtained, which will have a parallelepiped or box-like shape substantially corresponding to the shape of the inlet pipe 28.

When the mass of refuse R′ is compacted, the thruster member 31 can come into action, which until now had been inactive and in a retracted position. In the meantime, a new mass R1 of refuse is offloaded onto the presser element 35 to be compacted and crushed.

The thruster member 31 (see FIG. 4a) is translated by the rod 32 through the aperture 29 of the inlet pipe 28, then thrusts the mass of compacted refuse R′ through the mouth 27 of the transfer pipe 26, which preferably is the same size as the inlet pipe 28. In this stage the second presser element 37 is kept in the lowered position of FIG. 3d, to prevent any refuse or scrap from spilling from the pipe 28. The introduction element 24 in this stage is in a raised position inside the corresponding box 23, therefore possible previous loads of refuse to be crushed could spill in an unwanted manner from the crushing chamber 12. To prevent any such spillage of loads or residual refuse from the chamber 12 toward the outside of the crushing mill 10, the presser element 37 is kept in a lowered position so as to cover the inlet pipe 28.

When the mass of compacted refuse R′ advances into the crushing chamber 12 through the inlet aperture 14, the rotor 18 starts crushing using the hammers 21. As the rotor 18 gradually crushes the mass of refuse R′, the thruster member 31 thrusts the remaining part of the refuse outside the inlet pipe 28 and as far as near the bottom of the transfer pipe 26, where the aperture 14 of the crushing chamber 12 is positioned. FIG. 4b shows the thruster member 31 which is in a position of maximum advance toward the crushing chamber 12. In this step the second presser element 37 of the compactor apparatus 30 starts to be raised, to return at the end to the position shown in FIG. 3a. In this case, even if the introduction element 24 is in a raised position, it can be the thruster member 31 that guarantees the closure of the crushing chamber 12.

FIG. 4c shows a return step of the thruster member 31 to the initial position. While the thruster member 31 travels backward along the inlet pipe 28 of the compactor apparatus 30, the cylindrical sector introduction element 24 is rotated by suitable drive means so that it closes the crushing chamber 12 and starts to thrust inside it the part of compacted refuse R′ that has remained in the transfer pipe 26.

The function of the introduction element 24, in its operating conditions, is therefore to close the feed aperture 14 of the chamber 12 on each occasion, and when it is in the raised position, the accidental spillage of refuse or scrap from the crushing mill 10 is prevented by the presser element 37 in the closed position on the inlet pipe 28.

FIG. 4d shows the thruster member 31 completely retracted and outside the inlet pipe 28. In the meantime the introduction element 24 has been completely rotated so as to close the chamber 12 and thrust the last residues of refuse from the transfer pipe 26 to the crushing chamber 12. When the thruster member 31 has completely emerged from the inlet pipe 28, it is possible to proceed with a new load of refuse to be compacted inside the pipe 28 and to compact it as described with reference to FIGS. 3a, 3b, 3c, 3d. To this purpose, again in FIG. 4d, the second presser element 37 of the compactor apparatus 30 is shown, again in the lowered position for compacting a new mass of refuse to be crushed. In substance, advantageously, while the introduction element 24 completes the step of introducing the refuse inside the crushing chamber 12, it is possible to proceed with compacting a new mass of refuse through the compactor apparatus 30, so as to make the crushing process operated by the crushing mill 10 more efficient and continuous.

In substance, the step shown in FIG. 3a, in which both the presser element 37 and the conveyor element 35 are in an open position, is executed with the introduction element 24 in a closed position of the crushing chamber 12, while the step of compacting and transferring the compacted refuse to the crushing chamber 12 can take place with the introduction element 24 raised, since the presser element 37 is in a lowered position and in substance has the function of a lid for the inlet pipe 28 to feed the refuse or scrap to be crushed.

The crushing method performed by the crushing mill 10 according to the present invention is therefore advantageously continuous and without downtimes, since the crushing mill 10 is loaded with refuse to be crushed every time the presser element 35 moves to the positions shown in FIG. 3a or 3d, without any risk that possible residues of refuse, compacted or in the process of being crushed, can spill from the crushing mill 10, not even when both the presser elements 35 and 37 are open, thanks to the action of the introduction element 24 which is lowered and put to close the crushing chamber 12.

It is clear that modifications and/or additions of parts may be made to the crushing mill as described heretofore, without departing from the field and scope of the present invention.

It is also clear that, although the present invention has been described with reference to some specific examples, a person of skill in the art shall certainly be able to achieve many other equivalent forms of crushing mill, having the characteristics as set forth in the claims and hence all coming within the field of protection defined thereby.

1. Crushing mill, comprising a crushing chamber, an inlet pipe of the refuse to be crushed connected to said crushing chamber, and a thruster member associated to said inlet pipe and movable between at least an inactive position of loading the refuse to be crushed into said pipe and one or more active positions of thrusting the refuse to be crushed toward the crushing chamber, wherein it comprises a compactor apparatus for the refuse to be crushed provided with one or more presser elements positioned in correspondence to the inlet pipe of the refuse to be crushed and configured to be moved from at least a first inactive position, in which they allow the loading of the refuse to be crushed into said inlet pipe, to at least a second active position in which they compact said refuse in said pipe, the mass of compacted refuse in said inlet pipe being sent to the crushing chamber by means of said thruster member.

2. Mill as in claim 1, wherein it comprises an introduction element positioned between said compactor apparatus and said crushing chamber so as to selectively open or close the access to said crushing chamber.

3. Mill as in claim 2, wherein said introduction element is in an opening or closing position of the crushing chamber when at least one of said presser elements closes or opens the inlet pipe of the refuse.

4. Mill as in any claim hereinbefore, wherein said compactor apparatus comprises a first presser element positioned on a first side of said inlet pipe and a second presser element positioned on a second side of said inlet pipe opposite said first side, said first presser element being configured mainly to convey the refuse in said inlet pipe and said second presser element being configured mainly to compact the refuse.

5. Mill as in claim 4, wherein said first presser element is connected in a rotatable manner on said first side of the inlet pipe and comprises an arched containing surface of the refuse.

6. Mill as in claim 4, wherein said second presser element is connected in a rotatable manner on said second side of the inlet pipe and comprises a flat pressing surface.

7. Mill as in claim 1, wherein said inlet pipe has a box-like or parallelepiped shape and is open at the upper part to allow the loading of the refuse to be crushed.

8. Mill as in claim 1, wherein, downstream of said inlet pipe of the refuse to be crushed in the compactor apparatus, a transfer pipe is positioned to transfer the compacted refuse toward the crushing chamber, the cross section of the transfer pipe substantially corresponding to the cross section of the inlet pipe.

9. Mill as in claim 1, wherein said thruster member has a cross section with a shape substantially corresponding to that of the inlet pipe of the refuse to be crushed.

10. Mill as in claim 1, wherein said thruster member is mobile from at least a first extreme position in which it is positioned externally to said inlet pipe of the refuse to be crushed and a second extreme position in which it moves into proximity to a loading aperture of the mass of compacted refuse in the crushing chamber.

11. Method for treating refuse, such as scrap, which comprises moving a thruster member associated to an inlet pipe between an inactive position in which said refuse is loaded into said pipe and one or more active positions of thrusting said refuse in which said refuse is thrust toward a crushing chamber to be crushed, after loading said refuse into said pipe, it provides a compacting of the refuse with a compactor apparatus and, during said compacting, providing to move one or more presser elements, positioned in correspondence to said pipe, between a first inactive position in which they allow the loading of said refuse into said pipe, and a second active position in which they compact said refuse in said pipe, the mass of said compacted refuse being sent to said crushing chamber by means of said thruster member.

12. Method as in claim 11, wherein it provides open and closed steps of the crushing chamber synchronized with the closed and open steps of said inlet pipe to load the refuse to be treated, so that the crushing chamber is always closed toward the outside.

13. Method as in claim 11, wherein a first presser element performs a first compacting operation of the refuse to be compacted, thrusting it toward a second presser element, and said second presser element performs a second compacting operation at the end of which the compacted refuse is leveled and substantially has a shape corresponding to that of the inlet pipe.
